(19) United States
(12) Patent Application Publication
(10) Pub. No.: US 2026/0341662 A1
(43) Pub. Date: Oct. 29, 2026

(54) PORTABLE AEROSOL MASS SPECTROMETER

(71) Applicant: Zeteo Tech, Inc., Sykesville, MD (US)

(72) Inventors: Vadym Berkout, Rockville, MD (US); Wayne Bryden, Ellicott, MD (US); Scott Ecelberger, Woodbine, MD (US); Stuart Collymore, Hampstead, MD (US)

(21) Appl. No.: 19/051,997

(22) Filed: Feb. 12, 2025

Related U.S. Application Data
(60) Provisional application No. 63/552,745, filed on Feb. 13, 2024.

(51) Int. Cl. H01J 49/16; H01J 49/40; H01J 49/42

(52) U.S. Cl. CPC H01J 49/161; H01J 49/40; H01J 49/4225; H01J 49/424

(57) ABSTRACT

A portable mass spectrometer with improved detection of chemical composition of aerosol particles is provided.

### PRIORITY

This patent application claims the benefit of U.S. Provisional Patent Application No. 63/552,745, entitled “Portable Aerosol Mass Spectrometer” filed on Feb. 13, 2024, which is incorporated herein by reference in its entirety.

### FIELD

The present disclosure relates to the field of mass spectrometry (MS), in particular aerosol particle analysis in the environment.

### BACKGROUND

An aerosol is a heterogeneous mixture of fine solid particles or liquid microdroplets in a gas. It has been recognized that aerosols chemical composition affects many environmental, medical, and industrial problems. For rapid chemical analysis of aerosol particles in real-time time-of-flight (TOF) MS systems have been developed in recent years: ATOFMS^{1,2,3,4,5}, BAMS^{6,7}, SPLAT⁸, and a system developed at Delft University of Technology.^{9,10} All footnoted references are incorporated by reference herein, in their entirety. In these systems aerosol particles, sampled through the inlet, are transmitted into high vacuum of a TOF mass analyzer through a series of differentially pumped stages separated by small orifices (300-400 μm diameter).

Aerodynamic lenses collimate the particles to some extent along the centerline. The collimated particle beam then enters the light-scattering region, where, by measuring the time difference between scatter pulses from two laser beams, the speed of particle is determined. Speed is used to determine the time for firing a UV ionization laser when the particle enters the ionization region of TOF mass analyzer.

These systems are based on laser ionization of a single aerosol particle in the high vacuum (10⁻⁶ Torr or better) of the TOF mass analyzer. Such an approach results in low sensitivity, poor throughput, and poor mass resolution. Diminished sensitivity is due to aerosol losses during transfer through small orifices into the high vacuum stage and analysis of only a small portion of aerosol particles because of system idle time caused by the timing required to process a trigger, create an ionization pulse, and complete the mass spectrum data collection. Poor mass resolution is caused mostly by the spread of ion initial velocities in all directions. Additionally, the aerosol particle position in the ion source varies from particle to particle, and as a result, the peak position of ions with same m/z also vary from shot to shot. Subsequently, mass spectra averaging reduces mass resolving power and does not provide substantial gain in signal-to-noise ratio.

### SUMMARY

In a first aspect, the disclosure is directed to a portable analyzer system for determining chemical composition of aerosol particles. The portable analyzer system includes an aerosol inlet, such as a capillary tube or an orifice, configured to transfer aerosol particles in an aerosol beam into an ionization chamber. In some variations, the ionization chamber can be maintained between 0.1 Torr and 10 Torr. The ionization chamber includes a continuous laser configured to focus radiation on the aerosol beam at an aerosol detection focal point. The presence of scattered radiation indicates the presence of an aerosol particle in the aerosol particle beam. The ionization chamber further includes a pulsed laser configured to be incident on the aerosol beam at an ionization focal point. The ionization focal point is downstream from the detection focal point to ionize the aerosol particle. The portable analyzer system further includes a mass analyzer chamber operably associated with the ionization chamber. The mass analyzer is configured to detect the mass of the ions formed in the ionization chamber.

Separating of aerosol particle ionization and mass analysis of generated ions results in substantial increase in sensitivity of detection because ions formed at elevated pressures are cooled down in collisions with buffer gas and hence efficiently confined and transferred for mass analysis in high vacuum. Additionally, we increase the number of aerosol particles interrogated by ionization laser, since ionization and mass analysis are decoupled in the proposed system.

In a second aspect, the disclosure is directed to a portable analyzer system like that above. The ionization chamber includes a continuous laser incident on the aerosol beam at an ionization focal point both to detect and ionize the aerosol particles. The simultaneous aerosol particle detection and ionization results in a substantial increase in ion transmission for detection.

The portable analyzer system can include a number of additional components. In some variations, the aerosol chamber is configured to concentrate aerosol particles before entry into the aerosol inlet.

The ionization chamber further can include an ion focusing device.

In various aspects, the wherein the mass analyzer can include a linear orthogonal acceleration TOF mass spectrometer, an orthogonal acceleration TOF mass spectrometer with a reflector, a 3D ion trap mass spectrometer, a linear ion trap mass spectrometer, or a quadrupole mass spectrometer.

In some variations, the portable analyzer system includes an ion guide chamber disposed between and operably associated with the ionization chamber and mass analysis chamber, the ion guide chamber comprising an ion guide configured to focus ions into a small diameter (e.g., 1.0 mm or less) ion beam. In various aspects, the ion guide chamber can include an ion guide, such as a multipole guide. The multipole guide can be configured to operate in trap and release mode.

In some variations, the ionization chamber operates at a pressure of 0.1 Torr to 10 Torr. In further variations, the ion guide chamber has a pressure of from 10⁻³ Torr to 0.1 Torr. The mass analyzer can operate as a pressure of lower than 10⁻⁶ torr.

In some variations, the portable analyzer system can include an ion filtering device configured to select an ion within a mass range. The ion filtering device allows for the detection of product ions. In additional variations, the ion filtering device is disposed between and operably associated with the ion guide chamber and the mass analyzer chamber. The ion filtering device can include a mass resolving quadrupole, a fragmentation cell operably connected to the mass resolving quadrupole, and an ion guide operably connected to the ion fragmentation cell.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A. (Prior Art) depicts a top-down diagram of a prior art mass spectrometer in which aerosol particles are transferred into high vacuum of TOF mass analyzer through a series of small orifices, detected at multiple detection sites before ionization in the high vacuum region, and then mass analyzed by measuring their time-of-flight to an ion detector;

FIG. 1B depicts a top-down diagram of a mass spectrometer in which aerosol particles are detected and ionized simultaneously under high vacuum, according to an illustrative embodiment;

FIG. 2 depicts a top-down diagram of a mass spectrometer in which aerosol ionization and mass analysis of generated ions are separated in space, in accordance with an illustrative embodiment;

FIG. 3 depicts a top-down diagram of a mass spectrometer that includes aerosol particle detection, pulsed laser ionization, and subsequent ion focusing and transfer for mass analysis by a TOF mass analyzer using combination of ion funnel and ion guide, in accordance with an illustrative embodiment;

FIG. 4 depicts a top-down diagram of a mass spectrometer with continuous laser ionization and subsequent ion focusing and transfer for mass analysis by linear ion trap (LIT) mass analyzer using combination of ion funnel and ion guide, in accordance with an illustrative embodiment;

FIG. 5 depicts a top-down diagram of a mass spectrometer in which ion focusing, transfer, and fragmentation of ions of interest is performed by a mass resolving quadrupole, and mass analysis of fragments is performed by a TOF mass analyzer, in accordance with an illustrative embodiment;

FIG. 6 depicts ion focusing, transfer, fragmentation of ions of interest selected by mass resolving quadrupole and mass analysis of fragments by another quadrupole mass analyzer, in accordance with an illustrative embodiment;

FIG. 7A depicts a mass spectrum of insulin chain B and ubiquitin collected on the mass spectrometer of FIG. 1B, in accordance with an illustrative embodiment;

FIG. 7B depicts a mass spectrum of ubiquitin collected on the mass spectrometer of FIG. 1B, in accordance with an illustrative embodiment;

FIG. 7C depicts a mass spectrum of insulin chain B and ubiquitin collected on the mass spectrometer of FIG. 3, in accordance with an illustrative embodiment; and

FIG. 7D depicts a mass spectrum of ubiquitin collected on the mass spectrometer of FIG. 3, in accordance with an illustrative embodiment.

### DETAILED DESCRIPTION

Various features and advantages of the present disclosure will become apparent, taken in conjunction with the accompanying drawings. Reference will now be made in detail to representative embodiments illustrated in the accompanying drawings. It should be understood that the following descriptions are not intended to limit the embodiments to any one embodiment. To the contrary, it is intended to cover alternatives, modifications, and equivalents as can be included within the spirit and scope of the described embodiments as defined by the appended claims. Notably, any component can be used with any other component in any combination.

The phrase “operably connected to” as used herein refers to a direct operable connection between two components. The phrase “operably associated with” as used herein refers to a connection between two components that optionally includes intervening components.

In one variation of the disclosure, aerosol particle ionization and mass analysis of generated ions are separated but in close proximity in an ion beam. Aerosol particles can be ionized at higher pressures (e.g., 0.1-10 Torr), thus reducing particle losses associated with their transmission through multiple differentially pumped stages. The aerosol particles can be generated, for example, via a laser pulse incident on an aerosol particle. Ions are transferred via ion optics through differentially pumped stages into a high vacuum for mass analysis. Because ion optics focus ions into tight ion beam for efficient transfer, the sensitivity of the mass analyzer is increased as compared to inefficient aerosol particle transfer through small orifices into a high vacuum and subsequent ionization.

Because ionization and mass analysis are decoupled, the number of aerosol particles interrogated by ionization laser is increased. A well-defined ion beam provides for increased ion transmission to the mass analyzer, thereby increasing mass resolving power and stable mass calibration. During transfer from the aerosol particle ionization portion to the mass analyzer, abundant undesired ions and/or MS/MS analysis can be used to improve analysis of the ion or ions of interest.

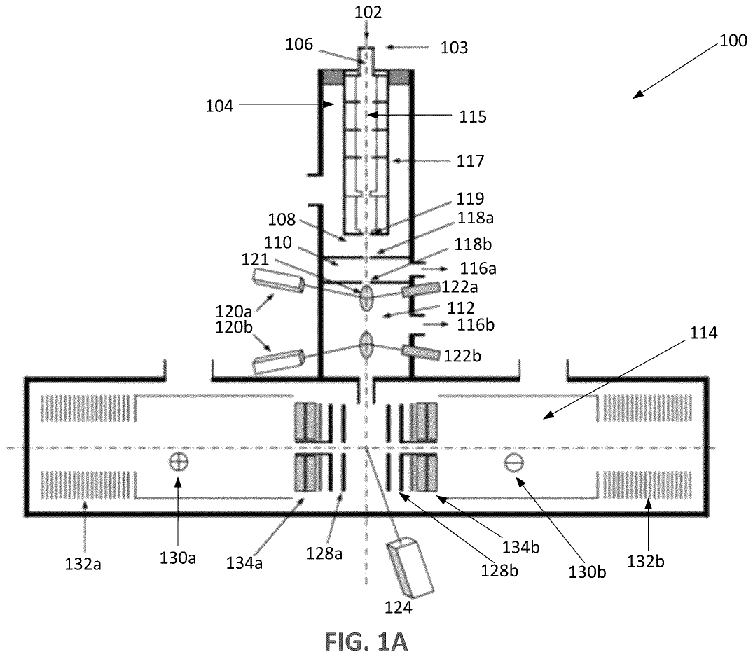

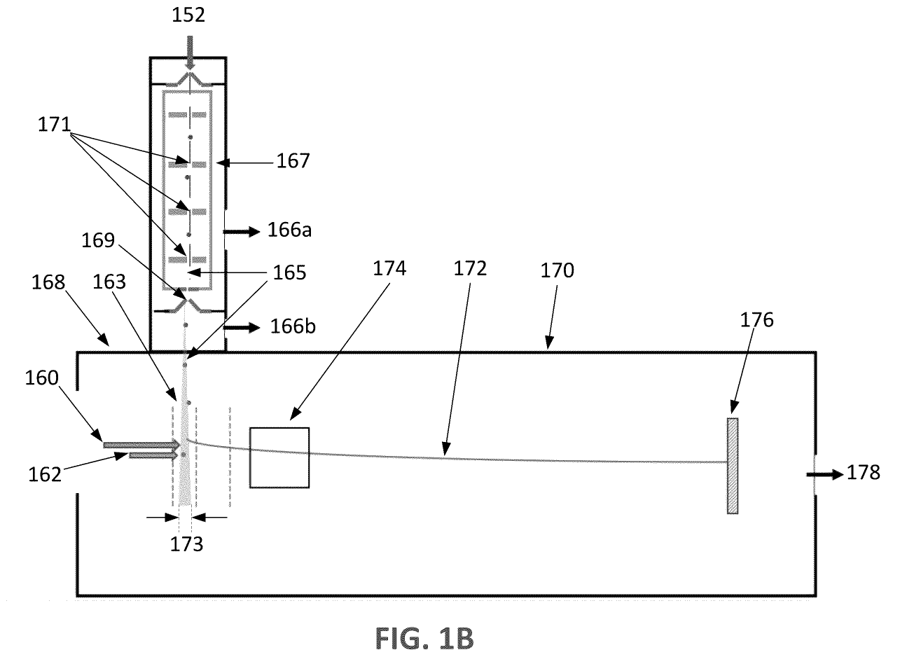

In FIG. 1A, the measurement of laser beam 120a, 120b (e.g., 532 nm) scattering by aerosol particle at two different points 122a and 122b provides particle velocity, thus determining the time required for aerosol particle to reach ionization source in TOF mass analyzer. The ionization laser is fired following determination of the particle velocity, and the resulting ions are mass analyzed by their time-of-flight to an ion detector.

Because the aerosol particle position in the ion source varies from particle to particle, and hence ions starting position changes, the mass accuracy of aerosol chemical composition by prior art mass analyzer 100 is low.

Additionally, during laser scattering event and subsequent mass analysis the system cannot analyze other aerosol particles (system idle time).

After the velocity of the aerosol particles are determined, a laser 124 is incident on an aerosol particle at point 126. Source plates 128a accelerate positive ions 130a to reflectron 132a and to detector 134a. Source plates 128b accelerate negative ions 130b to reflectron 132b and to detector 134b.

FIG. 1B depicts a schematic of a TOF mass analyzer 100. Aerosol particles 102 are drawn into a TOF mass analyzer by the pressure difference between atmosphere and first differentially pumped stage 104. Aerosol beam 115 is introduced through multiple pumping stages. Pump 116a reduces the pressure as aerosol beam 115 passes through aerodynamic lens 117 and nozzle 119, and pump 116b reduces the pressures still further as aerosol beam 115 enters ionization chamber 108. A set of small orifices 121 allows to drop the pressure from atmospheric to evacuated pressure.

Aerosol beam 115 expands as it enters ionization chamber 108, and accelerator region 113. Accelerator region 113 is a two stage ion extraction region orthogonal to the aerosol beam 115 direction. Aerosol particles in aerosol beam 415 is detected by trigger laser 110. Pulsed ionization laser 112 provides an immediate ionization laser pulse.

The device of FIG. 1B detects only positive ions or negative ions. It also does not measure individual aerosol particle velocities, followed by a delay before triggering the UV laser after an aerosol particle is observed. Particle ionization and mass analysis of generated ions both occur in a high vacuum.

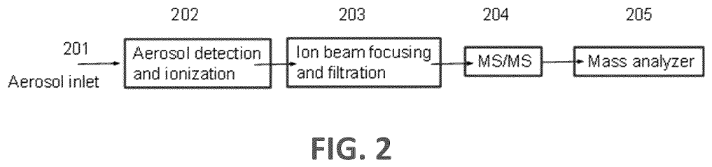

FIG. 2 depicts a top-down diagram of a mass spectrometer in which aerosol ionization and mass analysis of generated ions are separated in space. After passing through an inlet 201, aerosol particles are detected by laser scattering and ionized by ionization laser at elevated pressure 202. The ions produced during ionization are then focused into a narrow beam. Either a mass spectrum of parent ions or mass spectrum of product ions can then be acquired. If the mass spectrum of parent ions is determined, then the ions in the narrow beam can be filtered according to their m/z values by ion optics components 203 and passed to ion fragmentation cell 204. Fragment ions are then mass analyzed by mass analyzer 205. Alternatively, by not filtering the ions, the entire parent ion population can be analyzed by 205.

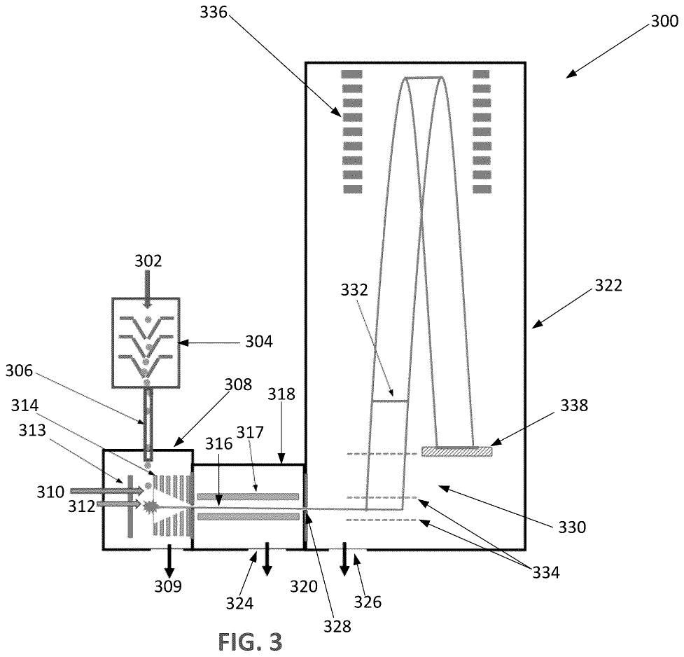

FIG. 3 depicts a top-down diagram of mass spectrometer 300 that includes aerosol particle detection within 1.0 mm or less within the location of pulsed laser ionization. Subsequently, ion focusing and transfer for mass analysis by a mass analyzer (e.g., a TOF mass analyzer) are accomplished using combination of ion funnel and ion guide.

Aerosol particles 302 are concentrated in an aerosol chamber 304, such as by a virtual impactor. An aerosol inlet 306, such as a capillary tube or aerosol orifice, transfers aerosol particles into an ionization chamber 308 operated at elevated pressure (e.g., 10 torr-10⁻¹ torr, depending on intake flow). For example, ionization chamber 308 can be evacuated using a pump 309, such as small diaphragm or scroll pump. The aerosol particles can form aerosol beam. Aerosol particles are detected using scattered light from a continuous (cw) laser 310 focused on the aerosol beam and a photomultiplier tube (PMT) (not shown). Pulsed ionization laser 312 (e.g., a UV laser focused to ~80 μm) is focused on the central axis of the aerosol particle beam, at a distance within 1.0 mm or less downstream from the cw laser 310. Pulsed ionization laser 312 is triggered to provide an ionization laser pulse at a specific delay (e.g., 0.1-5 microseconds) when triggered by the presence of an aerosol particle in the cw laser. The ionization pulse is thereby incident on the detected aerosol particle.

In any variation described herein, the distance between the focal point of the pulsed laser and the cw laser can have a lower boundary, and upper boundary, or combination of both as described in any variation as described herein.

In some variations, the focal point of the pulsed ionization laser in the aerosol particle stream is less than or equal to 1.0 mm from the focal point of the cw laser in the aerosol stream. In some variations, the focal point of the pulsed ionization laser in the aerosol particle stream is less than or equal to 0.9 mm from the focal point of the cw laser in the aerosol stream. In some variations, the focal point of the pulsed ionization laser in the aerosol particle stream is less than or equal to 0.8 mm from the focal point of the cw laser in the aerosol stream. In some variations, the focal point of the pulsed ionization laser in the aerosol particle stream is less than or equal to 0.7 mm from the focal point of the cw laser in the aerosol stream. In some variations, the focal point of the pulsed ionization laser in the aerosol particle stream is less than or equal to 0.6 mm from the focal point of the cw laser in the aerosol stream. In some variations, the focal point of the pulsed ionization laser in the aerosol particle stream is less than or equal to 0.5 mm from the focal point of the cw laser in the aerosol stream. In some variations, the focal point of the pulsed ionization laser in the aerosol particle stream is less than or equal to 0.4 mm from the focal point of the cw laser in the aerosol stream. In some variations, the focal point of the pulsed ionization laser in the aerosol particle stream is less than or equal to 0.3 mm from the focal point of the cw laser in the aerosol stream. In some variations, the focal point of the pulsed ionization laser in the aerosol particle stream is less than or equal to 0.2 mm from the focal point of the cw laser in the aerosol stream. In some variations, the focal point of the pulsed ionization laser in the aerosol particle stream is less than or equal to 0.1 mm from the focal point of the cw laser in the aerosol stream. In some variations, the focal point of the pulsed ionization laser in the aerosol particle stream is at least 0.01 mm from the focal point from the focal point of the cw laser in the aerosol stream.

In some variations, the focal point of the pulsed ionization laser in the aerosol particle stream is at least 0.01 mm from the focal point of the cw laser in the aerosol stream. In some variations, the focal point of the pulsed ionization laser in the aerosol particle stream is at least 0.1 mm from the focal point of the cw laser in the aerosol stream. In some variations, the focal point of the pulsed ionization laser in the aerosol particle stream is at least 0.2 mm from the focal point of the cw laser in the aerosol stream. In some variations, the focal point of the pulsed ionization laser in the aerosol particle stream is at least 0.3 mm from the focal point of the cw laser in the aerosol stream. In some variations, the focal point of the pulsed ionization laser in the aerosol particle stream is at least 0.4 mm from the focal point of the cw laser in the aerosol stream. In some variations, the focal point of the pulsed ionization laser in the aerosol particle stream is at least 0.5 mm from the focal point of the cw laser in the aerosol stream. In some variations, the focal point of the pulsed ionization laser in the aerosol particle stream is at least 0.6 mm from the focal point of the cw laser in the aerosol stream. In some variations, the focal point of the pulsed ionization laser in the aerosol particle stream is at least 0.7 mm from the focal point of the cw laser in the aerosol stream. In some variations, the focal point of the pulsed ionization laser in the aerosol particle stream is at least 0.8 mm from the focal point of the cw laser in the aerosol stream. In some variations, the focal point of the pulsed ionization laser in the aerosol particle stream is at least 0.9 mm from the focal point of the cw laser in the aerosol stream.

In additional variations the distance between the cw laser and pulsed ionization laser can be 10 mm or less. In some variations, the distance between the cw laser and pulsed ionization laser can be 5 mm or less. In some variations, the distance between the cw laser and pulsed ionization laser can be 2 mm or less.

The timing of the pulsed laser will be based on time required for aerosol particle to travel the distance between the focal point of the cw laser and the focal point of the pulsed ionization laser in the aerosol stream. The longer the distance, larger the delay of the pulsed laser. The timing can be readily selected by those of ordinary skill in the art.

In some variations, the cw laser and the pulsed ionization laser have the same focal point. In this circumstance, the delay between detection and the pulse of the ionization laser will be minimal, limited only by the time for detection and signaling of the pulsed ionization laser.

The cw laser 310 can be any continuous laser known in the art. Likewise, the pulsed ionization laser 312 can be any pulsed laser known in the art suitable for MALDI.

Generated ions are then accelerated via ion pusher 313 and focused, at high pressure (0.1 Torr to 10 Torr), by an ion focusing device 314 (e.g., an ion funnel, ion guide, ion funnel combined with an ion guide, or multipole ion guide) capable of focusing ions at the high pressures. The resulting ion beam 316 is then focused by an ion guide 317 (e.g., a radiofrequency (RF) ion guide, such as a quadrupole, hexapole or other multipole) at lower pressure in an ion guide chamber 318.

The ion guide chamber 318 can be differentially pumped with a separate vacuum pump 320. Alternatively, vacuum pump 320 can be used to pump both ion guide chamber 318 and mass analyzer chamber 322. For example, vacuum pump 320 can be a compact split flow turbo pump that evacuates the ion guide chamber 318 using the first inlet 324 and the mass analyzer chamber 322 (e.g., high vacuum TOF analyzer chamber) through the second inlet 326. In some variations, small pumps can be used to provide portability of the system.

After passing the aperture 328 between the ion guide chamber 318 the mass analyzer chamber 322, ions enter the acceleration region 330 of the TOF mass analyzer in zero electric field 332. The mass analyzer chamber 322 is maintained at high vacuum (e.g., 10⁻⁶ Torr or lower) by a turbomolecular section of the split flow vacuum pump 320. When the acceleration region 330 is filled with ions, a high voltage (“HV”) pulse is applied to accelerator plates 334, accelerating ions orthogonally in the time-of-flight direction. After ion reflection in a reflectron 336, the ions separated in time according to their mass are detected by an ion detector 338 (e.g., micro channel plates (MCP)).

Optionally, FIG. 3 can be operated without detection of cw laser 310. In such variations, there is no step of individual aerosol particle detection by laser scattering. Instead, pulsed ionization laser 312 operates in continuous mode and ionizes aerosol particles when they cross the focal spot of pulsed ionization laser 312. By operating the mass spectrometer device without a separate cw laser 310, the system is simplified, resulting in increased ion generation. The device may increase the power consumption of pulsed ionization laser 312.

Because aerosol particle ionization and mass analysis are separated in space there is no need for fast immediate analysis of generated ions. Accordingly, low speed mass analyzers such as quadrupole, 3D ion trap or linear ion trap can be used instead of a TOF mass analyzer. An additional advantage of ion traps is that they can operate at low vacuum (around 1 mTorr), thus further reducing pumping requirements for portable aerosol detection system.

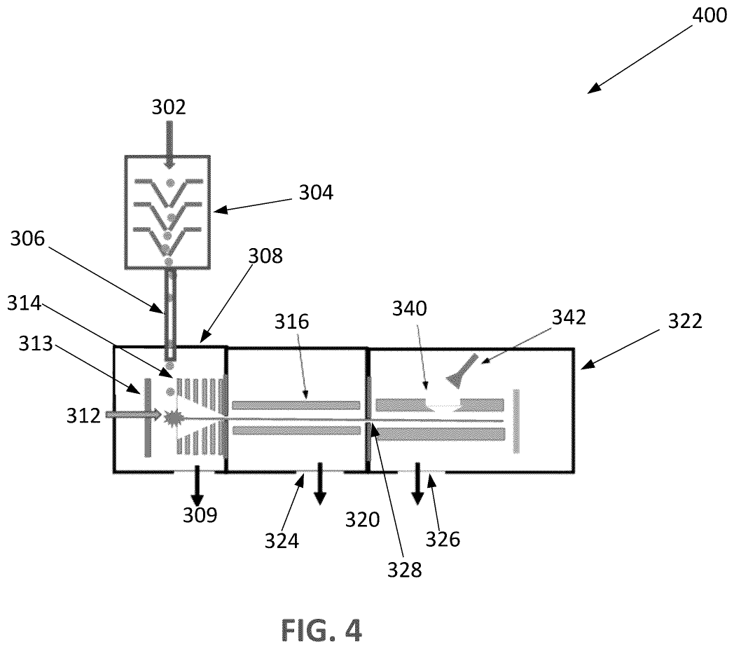

FIG. 4 depicts a top-down diagram of a mass spectrometer in which ion focusing, transfer, and fragmentation of ions of interest is performed by a mass resolving quadrupole linear ion trap. In FIG. 4,

Like the variation depicted in FIG. 3, in the variation of FIG. 4 aerosol particles 302 are concentrated by virtual impactor 304. Capillary tube inlet 306 transfers aerosol particles into an ionization chamber 308 operated at elevated pressure. Ionization chamber 308 can be evacuated using pump 309.

Unlike the variations of FIG. 3, in FIG. 4 ionization laser 312 operates in continuous mode, both detecting and ionizing aerosol particles when they cross the focal spot of ionization laser 312. Simultaneous aerosol detection and ionization increase ion transmission.

Like FIG. 3, in FIG. 4 the generated ions are accelerated via ion pusher 313 and focused, at high pressure (0.1 Torr to 10 Torr), by an ion focusing device 314. The resulting ion beam 316 is then focused by an ion guide 317 such as a quadrupole, hexapole or other multipole) at lower pressure in an ion guide chamber 318.

With further reference to FIG. 4, the ion guide chamber 318 can be differentially pumped with a separate vacuum pump 320. Alternatively, vacuum pump 320 can be used to pump both ion guide chamber 318 and mass analyzer chamber 322. For example, vacuum pump 320 can be a compact split flow turbo pump that evacuates the ion guide chamber 318 using the first inlet 324 and the mass analyzer chamber 322 (e.g., high vacuum TOF analyzer chamber) through the second inlet 326.

After passing the aperture 328 between the ion guide chamber 318 the mass analyzer chamber 322, ions enter linear ion trap 340. Ions can be selected and detected by ion detector 342.

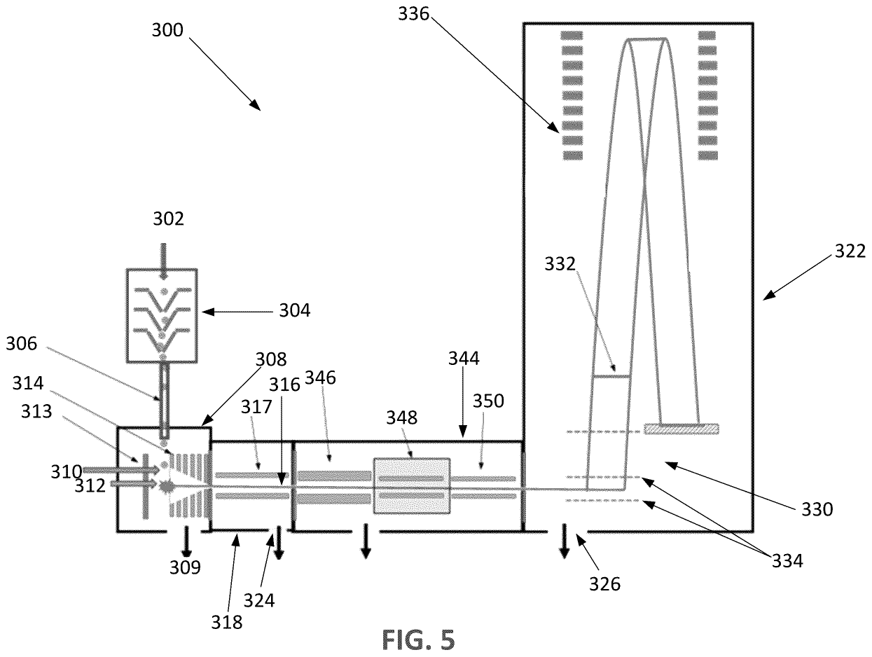

FIG. 5 depicts a top-down diagram of a mass spectrometer in which ion focusing, transfer, and fragmentation of ions of interest is performed by a mass resolving quadrupole, and mass analysis of fragments is performed by a TOF mass analyzer. An ion filtering device is placed between the ion guide chamber and the mass analyzer chamber.

Like the variation depicted in FIG. 3 and FIG. 4, in FIG. 5 the aerosol particles 302 are concentrated by virtual impactor 304. Capillary tube inlet 306 transfers aerosol particles into an ionization chamber 308 operated at elevated pressure. Ionization chamber 308 can be evacuated using pump 309.

Like FIG. 3, in the embodiment of FIG. 5 aerosol particles are detected using scattered light from a cw laser 310 and a photomultiplier tube (PMT) (not shown). Pulsed ionization laser 312 focused at the central axis less than 1.0 mm downstream from cw laser 310 is incident on aerosol particles. Pulsed ionization laser 312 is triggered to provide an ionization laser pulse at a specific delay (e.g., 0.1-5 microseconds) when triggered by the presence of an aerosol particle in the cw laser. The ionization pulse is thereby incident on the detected aerosol particle. As an alternative, the aerosol particles can be detected and ionized as described in FIG. 4. The cw laser 310 is excluded, and ionization laser 312 can operate in continuous mode, both detecting and ionizing aerosol particles when they cross the focal spot of the ionization laser 312.

This variation can be modified in any way by any variation described herein.

Like FIG. 3 and FIG. 4, in FIG. 5 the generated ions are accelerated via ion pusher 313 and focused, at high pressure (0.1 Torr to 10 Torr), by an ion focusing device 314. The resulting ion beam 316 is then focused by an ion guide 317 such as a quadrupole, hexapole or other multipole) at lower pressure in an ion guide chamber 318.

In the embodiment of FIG. 5, ion beam 316 leaves ion guide chamber 317 to ion filtering device 344. Ion filtering device 344 includes mass resolving quadrupole 346, ion fragmentation cell 348, and ion guide 350. An ion having a particular molecular weight (or range of molecular weights) is selected in ion filtering device 344. The selected ions are fragmented in ion fragmentation cell 348. The resulting fragment ions are focused to the mass analysis chamber 322.

Fragment ions entering mass analyzer chamber 322 then are accelerated in acceleration region 330. When the acceleration region 330 is filled with fragment ions, a high voltage (“HV”) pulse is applied to accelerator plates 334, accelerating ions orthogonally in the time-of-flight direction into zero electric field 332 region. After ion reflection in a reflectron 336, the ions separated in time according to their mass are detected by an ion detector 338 (e.g., micro channel plates (MCP)).

The ionization chamber 308, ion guide chamber 318, and ion filtering device 344 can be differentially pumped with a single vacuum pump. Alternatively, separate vacuum pumps can be used for one or more chambers.

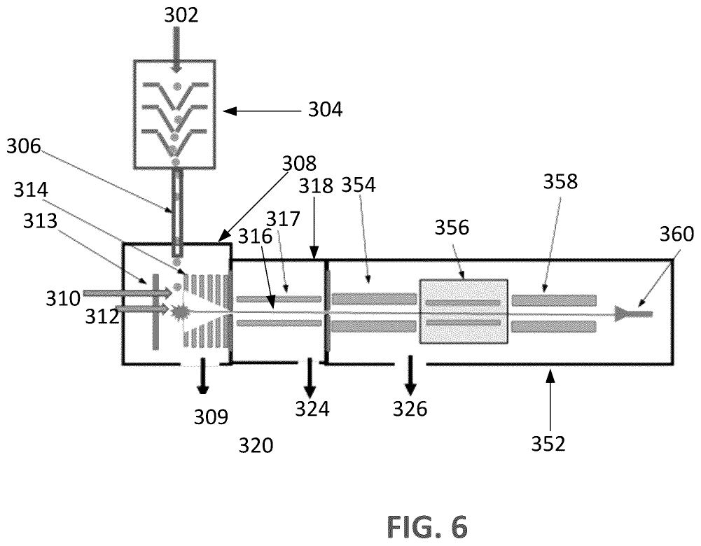

In some variations, the embodiment of FIG. 6 allows for the analysis of an aerosol chemical composition in case in which precursor ions have the same mass but different chemical structure.

Like the variation depicted in FIG. 3 and FIG. 4, in FIG. 6 the aerosol particles 302 are concentrated by virtual impactor 304. Capillary tube inlet 306 transfers aerosol particles into an ionization chamber 308 operated at elevated pressure. Ionization chamber 308 can be evacuated using pump 309.

In FIG. 6, aerosol particles are detected using scattered light from a cw laser 310 and a photomultiplier tube (PMT) (not shown). Pulsed ionization laser 312 focused at the central axis less than 1.0 mm downstream from cw laser 310 is incident on aerosol particles. Pulsed ionization laser 312 is triggered to provide an ionization laser pulse at a specific delay (e.g., 0.1-5 microseconds) when triggered by the presence of an aerosol particle in the cw laser. The ionization pulse is thereby incident on the detected aerosol particle.

As an alternative, the cw laser 310 is excluded, pulsed ionization laser 312 can operate in continuous mode, both detecting and ionizing aerosol particles when they cross the focal spot of the pulsed ionization laser 312. The aerosol particles can be detected and ionized by the ionization laser operated continuously, as described in FIG. 4.

In the embodiment of FIG. 6, ion beam 316 leaves ion guide chamber 317 to ion detection chamber 352. Ion detection chamber 352 includes mass resolving quadrupole 354, ion fragmentation cell 356, mass resolving quadrupole 358, and ion detector 360. An ion having a particular molecular weight (or range of molecular weights) is selected in mass resolving quadrupole 354. The selected ions are fragmented in ion fragmentation cell 356. The resulting fragment ions are separated by mass resolving quadrupole 358 and detected at ion detector 360.

In FIG. 6, evacuation of ion guide chamber and ion detection chamber 352 is performed by a compact split flow pump 320. Evacuation of the mass analyzer chamber (e.g., TOF mass analyzer or quadrupole) vacuum can be provided by high vacuum pump 326 (e.g., a small turbomolecular pump). Since there is already high vacuum in the ion guide chamber 318 (e.g., containing mass resolving quadrupole), the minute gas flow into TOF chamber will allow using high vacuum pump 326. High vacuum pump 326 can be designed such that it does not add significantly to size and weight of the system.

In various embodiments, any mass analyzer can be used instead of a TOF or quadrupole mass analyzer.

### Methods of Use

Any sample, including biological sample, can be analyzed by the methods described herein. Specifically, any low-volatility or non-volatile particulate or droplet sample can be analyzed using the devices and methods described herein. Particulate and droplet samples can include, but are not limited to, biologics, include drug targets, explosives, and other molecules.

Threats to humans from aerosolized biological particles arise from two sources intentional releases of biological warfare agents (BWA) and unintentional releases of pathogens from people infected with diseases such as COVID-19, influenza, or tuberculosis as they breathe, cough and sneeze. Weapons of mass destruction using BWA (i.e., bacterial spores, vegetative bacteria, viruses, toxins (proteins and peptides) and bioactive chemicals (drugs and other bioregulators)) continue to be a major threat. Additionally, military personnel frequent areas of the world with high rates of antibiotic resistant TB and other endemic diseases not commonly found in the United States.

Detection is based on MALDI (Matrix-Assisted Laser Desorption/Ionization) mass spectrometry, which over the past several years has become a gold standard clinical diagnostic tool. The system samples individual bioaerosol particles and uses laser-based, Time-of-Flight Mass Spectrometry (TOF MS) to determine the masses of the biomolecules (proteins, peptide, lipids, carbohydrates) across a wide mass range (100-100,000 Daltons).

While the bioidentifier has excellent specificity and sensitivity for nucleic acid-containing microbes, it also has outstanding specificity and sensitivity for biological toxins, and other biochemical threats. The threat databases for the sensor can instantly be updated at the system level, as signatures and algorithms improve, and new threats are added.

Rapid, real-time pathogen identification is a key aspect in preventive measures for infectious disease outbreaks. As with most respiratory pathogens, such diseases are primarily spread through human discharge of pathogen-containing droplets created by coughing, sneezing or even normal breathing. Mass spectrometry (MS) is a powerful analytical technique for fast identification of biomolecules because of its high speed, specificity and sensitivity. Real-time analysis of airborne particles containing pathogen organisms by portable MS-based system will help identify infected individuals and improve response and management to mitigate disease spread.

By ionizing aerosol particles outside of the high vacuum of mass analyzer performing accurate mass analysis by a miniature orthogonal acceleration time-of-flight (oaTOF) mass spectrometer, significantly improved analysis of airborne particles is realized. Abundant low mass ions will be filtered by an RF quadrupole ion guide, located between the ion source and the mass analyzer, thus substantially reducing noise in mass spectra. Higher mass ions of biomolecules will be cooled down in collisions with neutrals at intermediate pressure in the ion guide, providing well-defined ion beam for high-resolution mass analysis in oaTOF. Tight ion beam focusing allows using small diameter aperture separating high vacuum region of mass analyzer thus significantly reducing pumping requirements for the proposed system.

### EXAMPLE

The example is not intended to be limiting. Alternative embodiments within the scope of the claims will be envisaged by persons of ordinary skill in art.

### Example 1

Based on SIMION simulation results, an oaTOF mass spectrometer with two-stage acceleration and single-stage reflectron is designed and built. BPTOF hybrid ion detector with fast response time and extended dynamic range from Photonis is used for ion detection. Vacuum is provided by a SplitFlow turbomolecular pump SF200 from Pfeiffer backed by a diaphragm pump. Vacuum is typically about 4·10⁻⁷ Torr during experiments. High voltages are supplied by high stability, low noise HV power supplies from Spellman. A compact solid state laser Explorer® One™, Spectra Physics provides a short UV pulse at 349 nm with regulated pulse energy from 20 to 100 μJ. UV laser is triggered by scattered light produced when particle crosses focal point of cw green laser beam. UV ionization laser is tightly focused to the same spot as green laser, thus accurately irradiating bioaerosol particle. Generated ions are collimated by RF ion guide near the central axis. After entering the TOF mass analyzer, ions are accelerated orthogonally by applying push and pull high-voltage pulses to corresponding accelerator plates. These high voltage pulsers are based on a MOSFET stack (Model HTS 31-03-GSM, Behlke, Billerica, MA) which provides a fast rise time of about 20 ns.

Initial testing of the system is performed using ESI ion source and peptide and protein standards dissolved in acetonitrile/water 70/30 with 0.1% acetic acid. Miniature oaTOF mass spectrometer demonstrated mass resolving power over 3500 for multiply charged ions of small proteins.

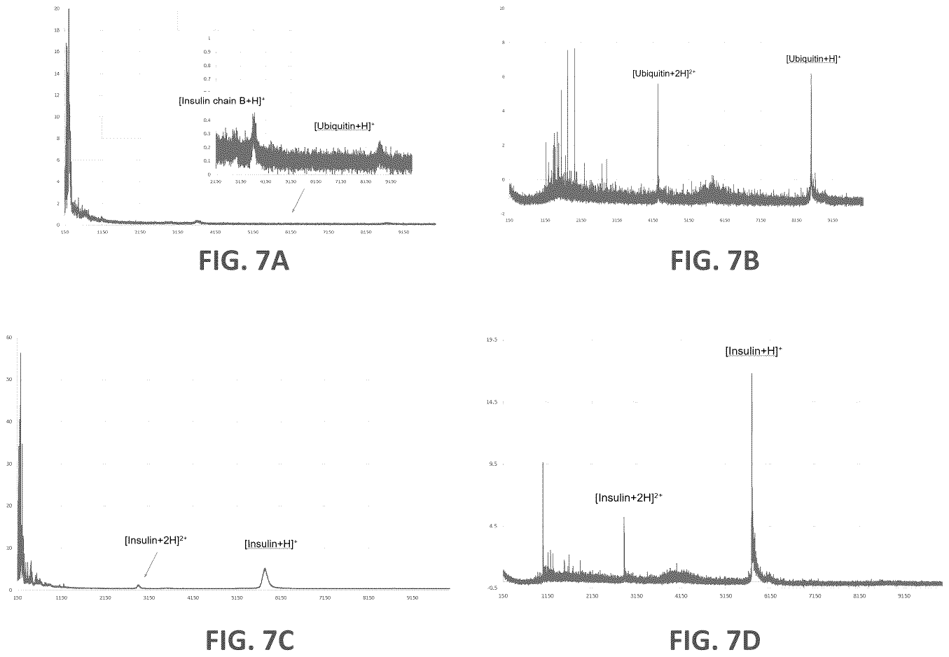

The mass spectra of FIGS. 7A and 7C were recorded using the mass spectrometer of FIG. 1B. The mass spectra of FIG. 7B and FIG. 7D were recorded using the mass spectrometer of FIG. 3. Analytes at concentration of 20 pmole/uL insulin chain B and ubiquitin for the mass spectra of FIGS. 7A and 7B, and 10 pmol/uL insulin for the mass spectra of FIGS. 7C and 7D were premixed with CHCA MALDI matrix and aerosolized. Each mass spectrum of FIGS. 7A-7D represents the average of a few hundred of individual spectra.

The mass spectra of FIGS. 7B and 7D as compared to those of FIGS. 7A and 7C demonstrate the significant improvements of mass spectrometers depicted in FIGS. 3-6 over the mass spectrometer of FIG. 1B. The mass spectrometer of FIG. 3 (like those of FIGS. 4-6) detects aerosol particles and ionizes analytes at pressures in the range of 0.1 Torr to 10 Torr. The mass spectrometer of FIG. 1B detects aerosol particles and ionizes analytes at high pressure. Further, operation of the mass spectrometer of FIG. 3 (like those of FIGS. 4-6) includes a time delay between detection of aerosol particles by continuous laser 310 and pulsed ionization laser 312, while operation of the mass spectrometer of FIG. 1B includes no time delay between particle detection and ionization.

As a result, low mass ions (m/z<200) are filtered out of mass spectra in FIGS. 7B and 7D. Further, FIGS. 7B and 7D show a substantial increase in mass resolving power (narrower mass peaks) than FIGS. 7A and 7C. The signal to noise ratio in the mass spectra of FIGS. 7B and 7D is substantially greater than that of FIGS. 7A and 7C because the analyte ion signal is “concentrated” in a narrower spectral range. FIGS. 3-6 do not have limitations on aerosol particle size. By contrast, mass spectrometer of FIG. 1B use aerodynamic lenses that limit aerosol particles to a size range of approximately 0.25 μm to 2.5 μm.

The described embodiments are intended to be examples only and are not intended to be limiting. Alternative embodiments within the scope of the claims will be envisaged by persons of ordinary skill in art.
. Card, E.; Mayer, J.E.; Morrical, B.D.; Dienes, T.; Fergenson, D.P.; Prather, K.A. Real-Time Analysis of Individual Atmospheric Aerosol Particles: Design and Performance of a Portable ATOFMS. Anal. Chem. 69 (1997 ), 4083.
2. Su, Y.; Sipin, M.F.; Furutani, H.; Prather, K.A. Development and Characterization of an Aerosol Time-of-Flight Mass Spectrometer with Increased Detection Efficiency, Anal. Chem. 76 (2004), 712.
3. Pratt, K.A.; Mayer, J.E.; Holecek, J.C.; Moffet, R.C.; Sanchez, R.O.; Rebotier, T.P.; Furutani, H.; Gonin, M.; Fuhrer, K.; Su, Y.; Guazzotti, S.; Prather, K.A. Development and Characterization of an Aircraft Aerosol Time-of-Flight Mass Spectrometer. Anal. Chem. 81 (2009 ), 1792.
4. Prather, K.A.; Mayer, J.E., Portable analyzer for determining size and chemical composition of an aerosol, U.S. Pat. No. 5,998,215 (1999).
5. Prather, K.A.; Mayer, J.E.; Gonin, M.; Fuhrer, K., Compact aerosol time-of-flight mass spectrometer, U.S. Pat. No. 8,648,294 (2014).
6. Fergenson, D. P.; Pitesky, M. E.; Tobias, H. J.; Steele, P. T.; Czerwieniec, G. A.; Russell, S. C.; Lebrilla, C. B.; Horn, J. M.; Coffee, K. R.; Srivastava, A.; Pillai, S. P.; Shih, M. T. P.; Hall, H. L.; Ramponi, A. J.; Chang, J. T.; Langlois, R. G.; Estacio, P. L.; Hadley, R. T.; Frank, M.; Gard, E. E., Reagentless Detection and Classification of Individual Bioaerosol Particles in Seconds. Anal. Chem. 76 (2004), 373.
7. Card, E.A.; Coffee, K.R.; Frank, M.; Tobias, H.J.; Fergenson, D.P.; Riot, V.J.; Steele, P.T.; Woods, B.W., Real-time detection method and system for identifying individual aerosol particles, U.S. Pat. No. 7,260,483 B2 (2007).
8. Zelenyuk, A., and D. Imre. Single particle laser ablation time-of-flight mass spectrometer: An introduction to SPLAT. Aerosol Sci. Technol. 39 (2005), 554.
9. Weiss, M., Verheijen, P., Marijnissen, J. C. M., & Scarlett, B. On the performance of an on-line time-of-flight mass spectrometer for aerosols. Journal of Aerosol Sciences, 28 (1996), 159.
10. Stowers, M.A.; Wuijckhuijse, A.L.; Marijnissen, J.C.M.; Kientz, C.E., Method and device for detecting and identifying bio-aerosol particles in the air, U.S. Pat. No. 6,806,464 B2 (2004).

What is claimed is:

1. A portable analyzer system for determining chemical composition of aerosol particles, comprising:
an aerosol inlet configured to transfer aerosol particles in an aerosol beam into an ionization chamber;
the ionization chamber comprising:
a continuous laser configured to focus radiation on the aerosol beam at an aerosol detection focal point, the presence of scattered radiation indicating the presence of an aerosol particle in the aerosol particle beam, and
a pulsed laser configured to be incident on the aerosol beam at an ionization focal point in the aerosol beam downstream from the aerosol detection focal point to ionize the aerosol particle; and
a mass analyzer chamber operably associated with the ionization chamber, the mass analyzer section configured to detect the mass of the ions formed in the ionization chamber.

2. The portable analyzer system of claim 1, further comprising an aerosol chamber configured to concentrate aerosol particles before entry into the aerosol inlet.

3. The portable analyzer system of claim 1, wherein the ionization chamber has a pressure of 0.1 Torr to 10 Torr.

4. The portable analyzer system of claim 1, further comprising an ion guide chamber disposed between and operably associated with the ionization chamber and mass analysis chamber, the ion guide chamber comprising an ion guide configured to focus ions into a small diameter less than 1.0 mm ion beam.

5. The portable analyzer system of claim 1, wherein the ion guide chamber has a pressure of from 10⁻³ Torr to 0.1 Torr.

6. The portable analyzer system of claim 1, wherein the aerosol inlet is a capillary tube.

7. The portable analyzer system of claim 1, wherein the aerosol inlet is an orifice.

8. The portable analyzer system of claim 1, wherein the ionization chamber comprises an ion focusing device.

9. The portable analyzer system of claim 1, wherein the ion guide comprises a multipole ion guide.

10. The portable analyzer system of claim 9, wherein the ion guide comprises operating in trap and release mode.

11. The portable analyzer system of claim 1, wherein the mass analyzer has a pressure of lower than 10⁻³ torr.

12. The portable analyzer system of claim 1, wherein the mass analyzer comprises a linear orthogonal acceleration time-of-flight mass spectrometer.

13. The portable analyzer system of claim 1, wherein the mass analyzer comprises an orthogonal acceleration time-of-flight mass spectrometer with a reflectron.

14. The portable analyzer system of claim 1, wherein the mass analyzer comprises a 3D ion trap mass spectrometer.

15. The portable analyzer system of claim 1, wherein the mass analyzer comprises a linear ion trap mass spectrometer.

16. The portable analyzer system of claim 1, wherein the mass analyzer comprises a quadrupole mass spectrometer.

17. The portable analyzer system of claim 1, further comprising an ion filtering device configured to select an ion within a mass range, the ion filtering device disposed between and operably associated with the ion guide chamber and the mass analyzer chamber.

18. The portable analyzer system of claim 17, wherein ion filtering device comprises a mass resolving quadrupole operably connected to the ion guide, a fragmentation cell operably connected to the mass resolving quadrupole, and an ion guide operably connected to the ion fragmentation cell.

19. A portable analyzer system for determining chemical composition of aerosol particles, comprising:
an aerosol inlet configured to transfer aerosol particles into an ionization chamber in an aerosol beam;
the ionization chamber comprising:
a continuous laser incident on the aerosol beam at an ionization focal point to detect and ionize the aerosol particles, and
an ion focusing device configured to concentrate the ions; and
a mass analyzer operably associated with the ionization chamber, the mass analyzer configured to detect the mass of the ions formed in the ionization chamber.

20. A portable analyzer system for determining chemical composition of aerosol particles, comprising:
an aerosol inlet configured to transfer aerosol particles into an ion source chamber;
the ionization chamber comprising an ion source at a pressure of 0.1 Torr to 10 Torr, the ion source comprising a laser incident on the aerosol particle beam at an ionization focal point to detect and ionize the aerosol particles;
ion guide chamber operably associated with the ionization chamber, the ion guide chamber comprising an ion guide configured to focus the ions into a diameter of less than 1.0 mm ion beam at a pressure of 10⁻³ Torr to 0.1 Torr;
an ion filtering device operably associated with the ion guide chamber, the ion filtering device comprising a mass resolving quadrupole operably connected to an ion fragmentation cell, the ion fragmentation cell operably connected to an ion guide;
ion transfer device which is transferring said fragment ions into high vacuum of mass analyzer; and
a mass analyzer which mass analyzes the said ion beam, the mass analyzer operating at a pressure of less than 10⁻⁶ torr.
